(19) United States
(12) Patent Application Publication
(10) Pub. No.: US 2025/0242740 A1
(43) Pub. Date: Jul. 31, 2025

(54) BOAT TRAILER STEP DEVICE

(71) Applicant: Jacob Lane, Athens, TN (US)

(72) Inventor: Jacob Lane, Athens, TN (US)

(21) Appl. No.: 18/423,422

(22) Filed: Jan. 26, 2024

(51) Int. Cl. B60P 3/10; B60R 3/00

(52) U.S. Cl. CPC B60P 3/1033; B60R 3/00

(57) ABSTRACT

A boat trailer step device includes a support arm having a first end joined to a mounting plate at a first fixed oblique angle; a top planar step joined to a second end of the support arm at a second fixed oblique angle; and at least one other planar step joined to the support arm between the mounting plate and the top planar step. The other planar step is laterally offset from the top planar step. The mounting plate, the top planar step, and the other planar step are arranged in parallel planes.

### BACKGROUND OF THE INVENTION

The present invention relates to boat trailers and, more particularly, to a boat trailer step device.

Users of boats who are very young, above middle age, overweight, or suffering some form of physical disability or ailment often have difficulty getting into and out of the boat when the boat is trailered.

Prior art boat trailer step assists are bolted together and must be assembled. They are also bulky, causing transportation issues when towing a boat.

As can be seen, there is a need for a boat trailer step device that does not need to be assembled, is not bulky, and provides easy access to and egress from a boat that is trailered or is in the process of being trailered.

### SUMMARY OF THE INVENTION

In one aspect of the present invention, a boat trailer step device comprises a mounting plate; a support arm having a first end joined to the mounting plate at a first fixed oblique angle; a top planar step joined to a second end of the support arm at a second fixed oblique angle; and at least one other planar step joined to the support arm between the mounting plate and the top planar step. The at least one other planar step is laterally offset from the top planar step. The mounting plate, the top planar step, and the at least one other planar step are arranged in parallel planes.

These and other features, aspects and advantages of the present invention will become better understood with reference to the following drawings, description, and claims.

### BRIEF DESCRIPTION OF THE DRAWINGS

FIG. 1 is a perspective view of a boat trailer step according to an embodiment of the present invention, shown in a use condition;

FIG. 2 is another perspective view thereof;

FIG. 3 is an exploded view thereof;

FIG. 4 is a perspective view of a boat trailer step according to another embodiment of the present invention, shown in a use condition; and

FIG. 5 is an exploded view thereof.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a step device that may be mounted to a boat trailer, making it easier to board a trailered boat by accessing the front portion of the boat. The step device disclosed herein is welded solid and is compact, sitting more centered on the trailer than prior art step devices.

While the size and shape of the components is not particularly limited, they may include, for example, a ¼″ thick plate, 11-gauge square tubing, and Schedule 40 pipe with a 1″ nominal inside diameter. Mounting hardware may include square U bolts with ⅜-inch rod diameter, otherwise dimensioned to accommodate a trailer tongue.

While the materials of manufacture are not particularly limited, the selected materials must be resistant to corrosion, must be rigid, and must retain the device's strength to avoid injury to the user. For example, the components may be made of steel or may be zinc plated.

To make the step device, the manufacturer may cut the metal components to predetermined sizes, fully weld the metal components together, media blast the welded components, and powder coat the media-blasted device.

To use the step device, a user may mount the steps to a boat trailer on top of the trailer tongue with U bolts and install a grab handle. The user may then step from the ground to the trailer steps and onto the boat.

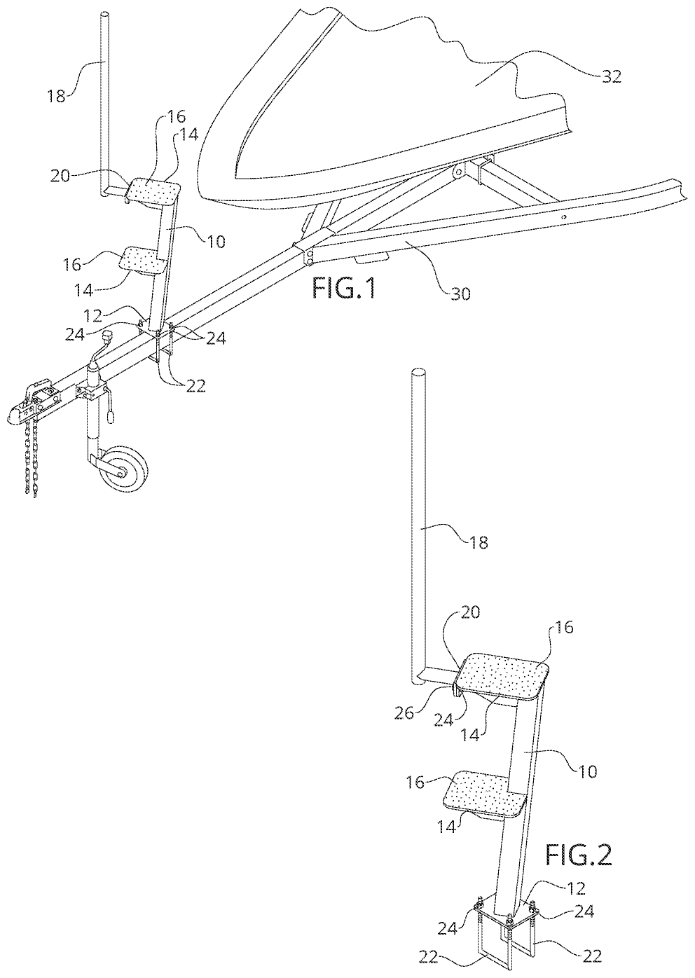

Referring to FIGS. 1 through 5, a boat trailer step device according to an embodiment of the present invention comprises a main bar 10 rising at a fixed angle from a mounting plate 12. The mounting plate 12 may be a square metallic component and the main bar 10 may be a square metallic tube. Planar steps 14 are joined to the main bar 10 and are arranged laterally offset in parallel planes to one another with a predetermined spacing. One of the steps 14, i.e., the top step, is fixed to an end of the main bar 10 opposite the mounting plate 12.

The fixed angles of the mounting plate 12, the main bar 10, and the steps 14 give the step device a number “7” profile; see FIG. 2.

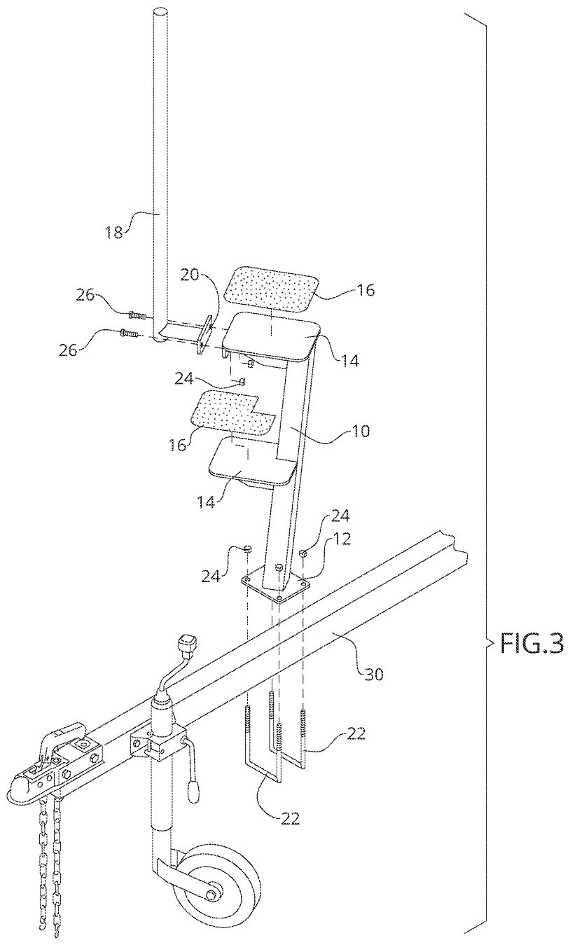

As shown more clearly in FIG. 3, the top step 14 has a mounting plate extending downward perpendicularly from an edge of the step 14. Each step 14 is provided with traction material 16 for user safety and may have a reinforcement component joined to its bottom surface. A handle 18 having a handle mount 20 extending therefrom is fastened to the top step 14 mounting plate with fastening hardware such as nuts 24 and bolts 26, with the handle extending upward at a substantially right angle from the top step 14. The mounting plate 12 has apertures operative to accommodate U bolts 22, enabling the step device to be fastened to a trailer 30 tongue, with the mounting plate 12 resting upon the tongue, adjacent to its tongue jack, enabling easy access to a boat 32 on the trailer.

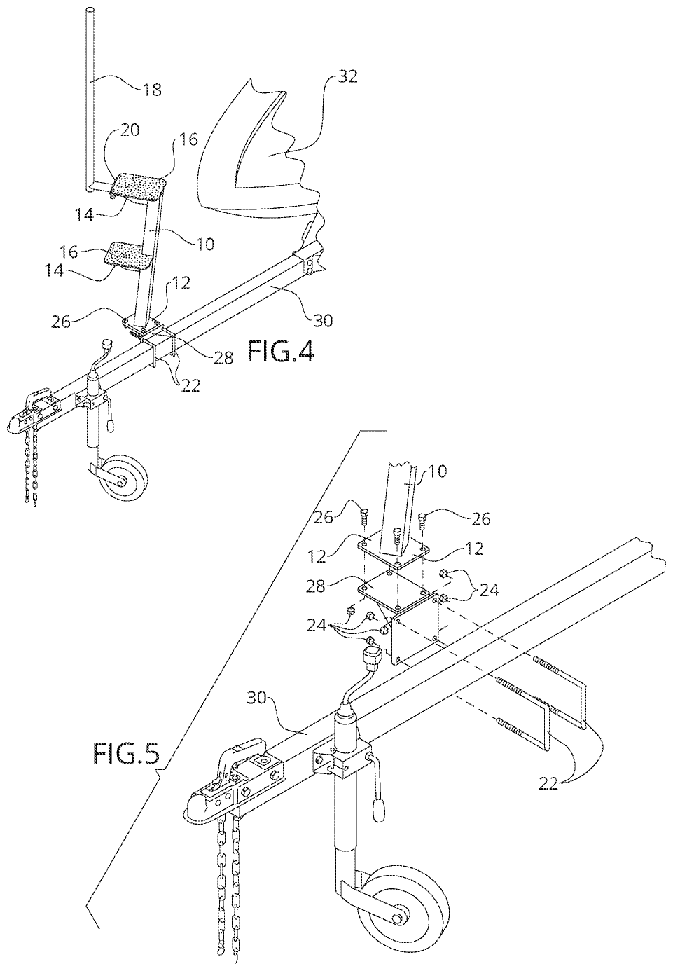

In another embodiment illustrated in FIGS. 4 and 5, an adaptor 28, having a pair of plates joined in a perpendicular configuration, may be fastened to the mounting plate 12 with nuts 24 and bolts 26. The adaptor 28 has apertures operative to accommodate U bolts 22, enabling the adaptor 28 to be fastened to the trailer 30 tongue such that the mounting plate 12 is offset laterally from the tongue.

It should be understood, of course, that the foregoing relates to exemplary embodiments of the invention and that modifications may be made without departing from the spirit and scope of the invention as set forth in the following claims.

What is claimed is:

1. A boat trailer step device, comprising:
a mounting plate;
a support arm having a first end joined to the mounting plate at a first fixed oblique angle;
a top planar step joined to a second end of the support arm at a second fixed oblique angle; and
at least one other planar step joined to the support arm between the mounting plate and the top planar step, wherein the at least one other planar step is laterally offset from the top planar step; and wherein the mounting plate, the top planar step, and the at least one other planar step are arranged in parallel planes.

2. The boat trailer step device of claim 1, wherein the top planar step and the at least one other planar step have a nonslip top surface.

3. The boat trailer step device of claim 1, wherein the mounting plate has apertures operative to accommodate U bolts.

4. The boat trailer step device of claim 1, further comprising an adaptor comprising two perpendicularly joined adaptor plates;
wherein the two perpendicularly joined adaptor plates are operative to fasten to the mounting plate and to a trailer tongue, respectively.

5. The boat trailer step device of claim 1, further comprising:
a top step mounting plate extending perpendicularly from an edge of the top planar step, and
an elongated handle having a handle mount coupled to the top step mounting plate.

6. The boat trailer step device of claim 5, wherein the elongated handle is formed with a right angle bend and is operative to extend perpendicular to the top planar step.
